(19) United States
(12) Patent Application Publication
(10) Pub. No.: US 2016/0340153 A1
(43) Pub. Date: Nov. 24, 2016

(54) SYNCHRONIZED OPERATING MECHANISM FOR ELEVATOR DOORS

(71) Applicant: Bella Elevator, LLC, Peoria, IL (US)

(72) Inventors: Rick Reysen, Eureka, IL (US); Kevin L. Heyungs, Eureka, IL (US)

(21) Appl. No.: 15/157,230

(22) Filed: May 17, 2016

Related U.S. Application Data
(60) Provisional application No. 62/164,439, filed on May 20, 2015.

(51) Int. Cl. B66B 13/12; B66B 5/02; B66B 13/08; B66B 19/00; B66B 13/30

(52) U.S. Cl. CPC B66B 13/12; B66B 19/00; B66B 13/303; B66B 13/08; B66B 5/02

(57) ABSTRACT

An elevator door assembly includes a plurality of door panel assemblies. Each door panel assembly includes a respective door panel and an associated hanger assembly. The hanger assemblies are configured to provide synchronized opening and closing of the door panel assemblies. The elevator door assembly also includes a detent mechanism coupled to the plurality of door panel assemblies to provide a mechanical back up mechanism that enables the door panel assemblies to be opened and closed in an event of a failure of at least one of the associated hanger assemblies.

### FIELD OF THE INVENTION

The present invention relates generally to elevators, and more particularly, to a system and method for operating elevator doors in a synchronized manner.

### BACKGROUND

Elevators include one or more doors to allow users to enter and exit the elevator. Typical elevator doors include one or two door panels that are operated by a motorized mechanism to open and close the doors. While convenient, such elevator doors are subject to failures of one or more components that may cause the elevator doors to cease operating. This can be dangerous if users happen to be inside the elevator when the motorized mechanism or other component of the elevator door fails.

Some older elevator doors are manually operated. Examples of manually operated elevator doors include a screen or other movable barrier that may be pulled back or opened outward by a user to allow the user to enter and exit the elevator. However, these elevator doors may be cumbersome and slow to open and close.

### BRIEF SUMMARY OF THE INVENTION

In one embodiment, an elevator door assembly is disclosed that includes a plurality of door panel assemblies. Each door panel assembly includes a respective door panel and an associated hanger assembly. The hanger assemblies are configured to provide synchronized opening and closing of the door panel assemblies. The elevator door assembly also includes a detent mechanism coupled to the plurality of door panel assemblies to provide a mechanical back up mechanism that enables the door panel assemblies to be opened and closed in an event of a failure of at least one of the associated hanger assemblies.

In another embodiment, a method of assembling an elevator door is disclosed. The method includes providing a plurality of door panels and a plurality of hanger assemblies, and coupling each door panel of the plurality of door panels to a respective hanger assembly of the plurality of hanger assemblies to form a plurality of door panel assemblies. The hanger assemblies provide synchronized opening and closing of the door panel assemblies. The method also includes coupling a detent mechanism to the plurality of door panel assemblies to provide a mechanical back up mechanism that enables the door panel assemblies to be opened and closed in an event of a failure of at least one of the associated hanger assemblies.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a first isometric illustration of a portion of an elevator door assembly, according to a first embodiment of the present invention;

FIG. 2 is a second isometric illustration of a portion of the elevator door assembly of FIG. 1;

FIG. 3 is a isometric illustration of a portion of an elevator door assembly in a reverse configuration, according to the first embodiment of the present invention;

FIG. 4 is a isometric illustration of an enlarged portion of the elevator door assembly of the first embodiment, illustrating a detent mechanism in a first position;

FIG. 5 is a isometric of the enlarged portion of the elevator door assembly of FIG. 4, illustrating the detent mechanism in a second position;

FIG. 6 is a top down diagrammatic illustration of the detent mechanism of FIGS. 4 and 5 in almost fully closed position with no failure of the synchronizer mechanism;

FIG. 7 is a top down diagrammatic illustration of the detent mechanism of FIGS. 4 and 5 in a fully closed position when there has been a failure of the synchronizer mechanism;

FIG. 8 is a top down diagrammatic illustration of the detent mechanism of FIGS. 4 and 5 in an almost fully open position with no failure of the synchronizer mechanism;

FIG. 9 is a top down diagrammatic illustration of the detent mechanism of FIGS. 4 and 5 in a fully open position when there has been a failure of the synchronizer mechanism;

FIG. 10 is an isometric illustration of a portion of an elevator door assembly of a second embodiment of the present invention;

FIG. 11 is a second isometric illustration of a portion of the elevator door assembly according to the second embodiment of the present invention;

FIGS. 12A-12C are diagrammatic illustrations of the first and second embodiments of the elevator door assembly illustrating an envelope thereof;

FIGS. 13A and 13B are first and second isometric illustrations of an eccentric plate hanger assembly, according to an embodiment of the present invention;

FIG. 14 is an exploded diagrammatic illustration of a first elevator door assembly, according to an embodiment of the present invention; and

FIG. 15 is an exploded diagrammatic illustration of a second elevator door assembly, according to an embodiment of the present invention.

### DETAILED DESCRIPTION OF INVENTION

In the embodiments described herein, a synchronized elevator door assembly is described that is operable in several modes of operation. The different modes of operation provide various mechanical backup mechanisms to enable the elevator door to be opened and closed in an event of a mechanical or electrical failure of one or more components of the door.

The elevator door assembly includes a plurality of door panels that each includes a respective hanger assembly. In the embodiments described herein, the elevator door assembly includes three door panels, each of which includes a hanger assembly coupled thereto. However, it should be recognized that any suitable number of door panels and hanger assemblies may be used.

In one embodiment, each hanger assembly includes a pair of hanger pulleys that enables each door panel to move along a track towards an open position or towards a closed position. The first door panel is coupled to a cable extending between a first pair of hanger pulleys of the second hanger assembly, and the second door panel is coupled to a cable extending between a second pair of hanger pulleys of the third hanger assembly. In such a configuration, movement of the first door panel also causes the movement of the second door panel and the third door panel in a synchronized manner. In one embodiment, a motor is coupled to one of the hanger assemblies to effectuate movement of the hanger assembly and its associated door panel. The motorized movement of the hanger assembly then automatically causes synchronized movement of the other hanger assemblies and their associated door panels.

In an event of a failure of the motor, a handle is provided on one of the door panels to enable a user to manually open or close the door panels. The manual opening or closing of the door panels is also conducted in a synchronized manner due to the operation of the hanger assemblies and the associated hanger pulleys.

A detent mechanism provides another mechanical backup to the elevator door assembly. In one embodiment, a tab is coupled to opposing sides of each door panel. If the hanger assemblies fail (e.g., if a cable of the hanger pulleys breaks), a user may pull the handle attached to the door panel to move that door panel towards the open or closed position. As the door panel moves, a tab of that door panel engages with a corresponding tab of an adjacent door panel to cause the door panels to move in a step-wise manner. As a result, a robust elevator door assembly is provided that may be opened and closed in a fast and convenient manner.

As used herein, the term “synchronized” refers to a joint movement of components where each synchronized component moves at substantially the same time as each other synchronized component. Thus, when elevator door panels are moved in a synchronized manner, each door panel moves at substantially the same time as each other door panel. Therefore, the initiation of movement of one door panel causes the initiation of movement of each other door panel, and the cessation of movement of one door panel causes the cessation of movement of each other door panel.

As used herein, the term “step-wise” refers to a movement of components in which a first component begins to move, which then causes the movement of another component at a later time. Thus, when elevator door panels are moved in a step-wise manner, a first door panel begins moving while the other door panels are stationary. At a later time (e.g., when the first door panel reaches a point at which a tab on the first door panel engages a tab on a second door panel), the second door panel begins moving along with the first door panel. If the first door panel stops moving, the second door panel may continue to move in certain embodiments.

Referring to the Figures, wherein like numerals indicate like or corresponding parts throughout the several views, an elevator door assembly 10 is provided. In one aspect of the present invention, the elevator door assembly 10 is non-motorized, i.e., the doors of the elevator door assembly must be opened and closed manually. In another aspect of the present invention, the elevator door assembly is motorized.

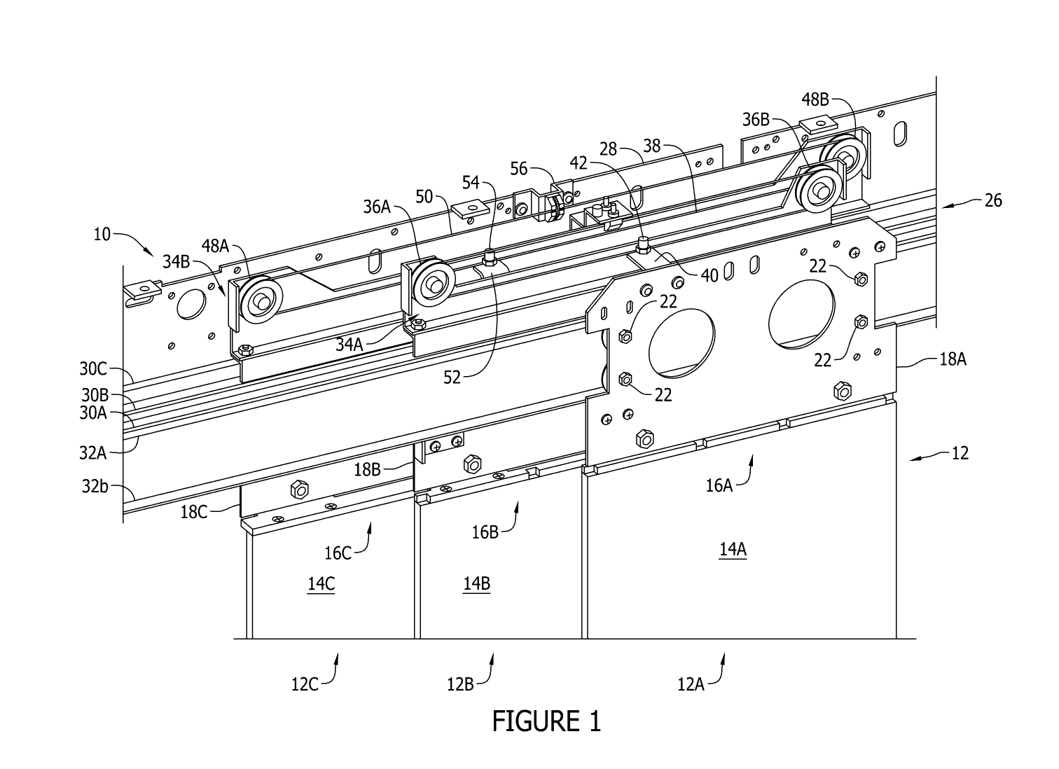

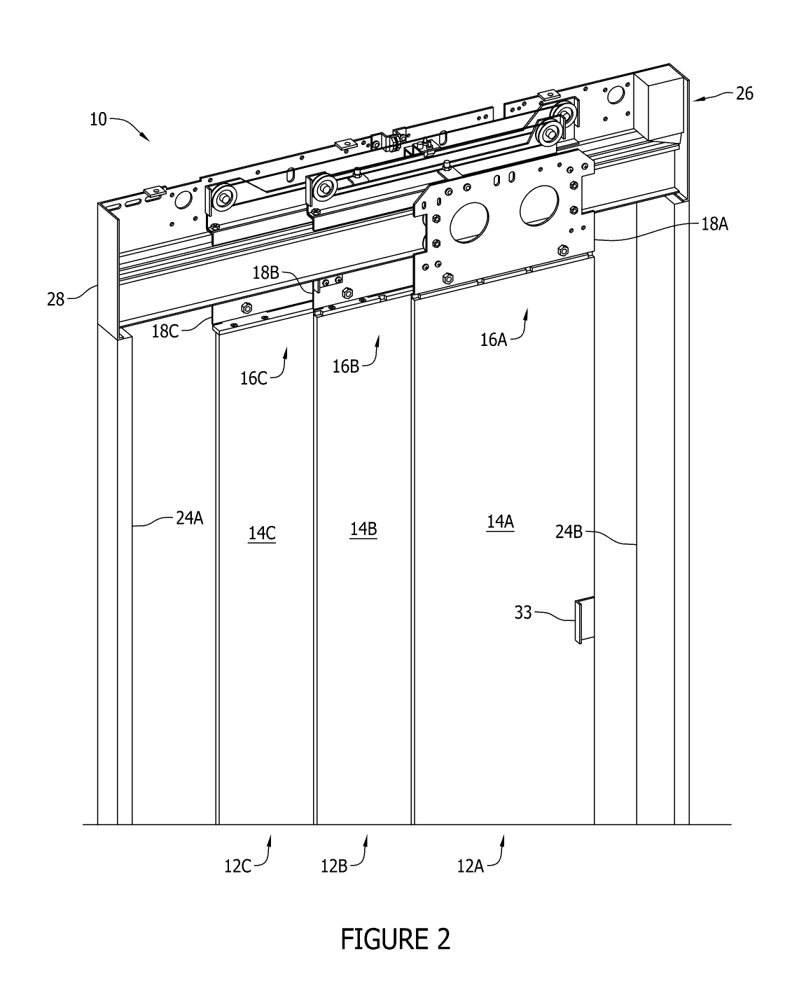

With respect to FIGS. 1 and 2, an elevator door assembly 10, according to a first embodiment of the present invention is provided. The elevator door assembly 10 is comprised of a plurality of door panel assemblies 12. In the illustrated embodiment, the elevator door assembly 10 includes first, second, and third elevator door panel assemblies 12A, 12B, 12C. Each door panel assembly includes a door panel 14A, 14B, 14C, and a hanger assembly 16A, 16B, 16C. The hanger assemblies 16A-16C are collectively referred to as a “synchronizer mechanism”.

The first door panel assembly 12A includes the first door panel 14A and the first hanger assembly 16A. The first hanger assembly 16A includes a first hanger plate 18A. Four first rollers 20A (two of which are visible in FIGS. 1 and 2) are rotatably mounted to the first hanger plate 18A by four fasteners 22.

As shown in FIG. 2, the elevator door assembly 10, in use, is located within a door opening defined by a first door jamb 24A and a second door jamb 24B. The door opening is further defined by a floor or surface of the floor (not shown), and an upper assembly 26. The upper assembly 26 includes a housing 28 that rests atop, and is coupled to, the door jambs 24A, 24B. Mounted to the housing 28 are first, second, and third tracks 30A, 30B, 30C. Each track 30A, 30B, 30C defines an upper and lower channel 32A, 32B.

An upper pair of the first rollers 20A are located within the upper channel 32A of the first track 30A and a lower pair of the first rollers 20A are located within the lower channel 32B. This arrangement allows the first door panel assembly 12A to move in first and second horizontal directions along the first track 30A.

In the first embodiment, as shown In FIGS. 1 and 2, the elevator door assembly 10 is manually operated. A handle 33 (shown in FIG. 2) coupled to the first door panel 14A may be used to open and close elevator assembly (see below).

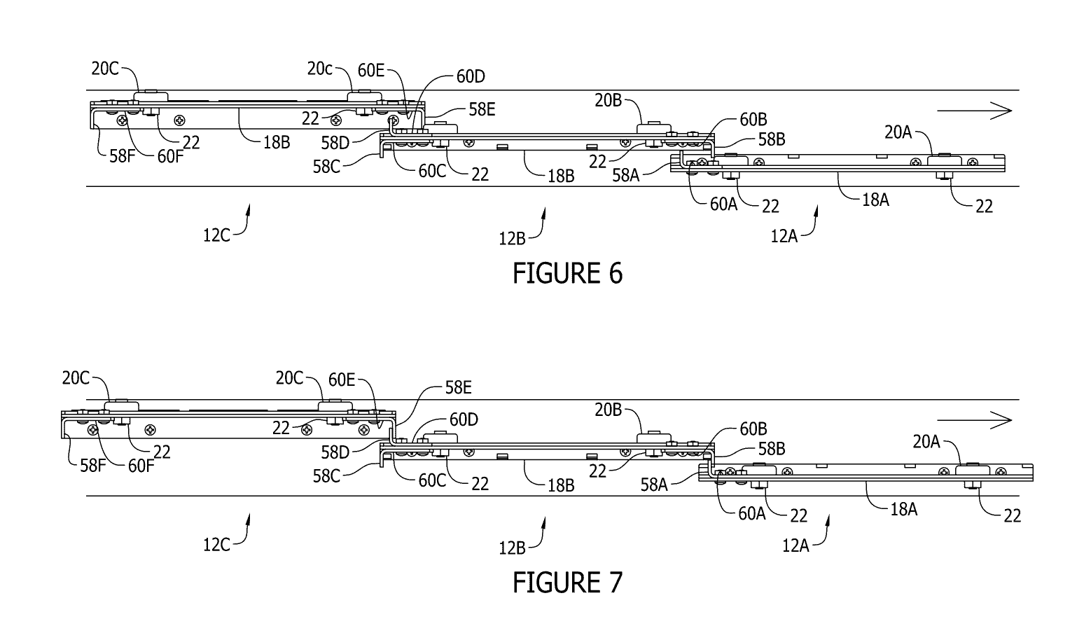

The second door panel assembly 12B includes the second door panel 14B and the second hanger assembly 16B. The second hanger assembly 16B includes a second hanger plate 18B. Four second rollers 20B (two of which are visible in FIGS. 6, 7, 8, and 9) are rotatably mounted to the second hanger plate 18B by four fasteners 22.

An upper pair of the second rollers 20B are located within the upper channel 32A of the second track 30B and a lower pair of the second rollers 20B are located within the lower channel 32B of the second track 30B. This arrangement allows the second door panel assembly 12B to move in first and second horizontal directions along the second track 30B.

The second hanger assembly 16B includes a second hanger roller assembly 34A affixed to the top of the second hanger plate 18B. The second hanger roller assembly 34A includes a pair of second hanger pulleys 36A, 36B. The second hanger pulleys 36A, 36B are mounted on opposite ends of the second hanger plate 18B. Each of the second hanger pulleys 36A, 36B have a U-shaped inner channel. Suspended between the second hanger pulleys 36A, 36B is a second hanger cable 38. The second hanger cable 38 is shaped to be complimentary to the U-shaped inner channels.

An L-shaped bracket 40 has one end mounted to the first hanger plate 18A and a second end which is fixedly coupled to a lower side of the second hanger cable 38 via a fastener 42. This arrangement couples the second door panel assembly 12B to the first door panel assembly 12A (see below).

The third door panel assembly 12C includes the third door panel 14C and the third hanger assembly 16C. The third hanger assembly 16C includes a third hanger plate 18C. Four third rollers 20C (two of which are visible in FIGS. 6, 7, 8, and 9) are rotatably mounted to the third hanger plate 18C by four fasteners 22.

An upper pair of the third rollers 20C are located within the upper channel 32A of the third track 30C and a lower pair of the third rollers 20C are located within the lower channel 32B of the third track 30C. This arrangement allows the third door panel assembly 12C to move in first and second horizontal directions along the third track 30C.

The third hanger assembly 16C includes a third hanger roller assembly 34B affixed to the top of the third hanger plate 18C. The third hanger roller assembly 34B includes a pair of third hanger pulleys 48A, 48B. The third hanger pulleys 48A, 48B are mounted on opposite ends of the third hanger plate 18C. Each of the third hanger pulleys 48A, 48B have a U-shaped inner channel. Suspended between the third hanger pulleys 48A, 48B is a third hanger cable 50. The third hanger cable 50 is U-shaped such as to be complimentary to the U-shaped inner channels.

A second L-shaped bracket 52 has one end mounted to the second hanger plate 18B and a second end which is fixedly coupled to a lower side of the third hanger cable 50 via a fastener 54. This arrangement couples the third door panel assembly 12C to the second door panel assembly 12B (see below).

As shown in FIGS. 1 and 2, a bracket (or dead end bracket) 56 is mounted to the housing 28 of the upper assembly 26. The third hanger cable 50 is fixedly coupled to the bracket 56.

The arrangement described above, including the door panel assemblies 12 and the interconnections therebetween, provide for the simultaneous opening and closing of the door panels. In the first embodiment, described above, the opening and closing of the elevator door assembly 10 is effected through manual operation utilizing the handle 33. From a fully open position in which all three door panels are retracted to the left, application of force to the handle 33 initiates movement of the first door panel assembly 12A to the right. The first door panel assembly 12A may be moved to the right until a right edge of the first door panel 14A reaches the door jamb 24B.

By virtue of the connection between the first hanger plate 18A and the second hanger cable 38, the second door panel assembly 12B is actuated by movement of the first door panel assembly 12A. As the first door panel assembly 12A moves towards the closed position, the connection between the first hanger plate 18A and the second hanger cable 38 causes the second hanger cable 38 to rotate about the second hanger pulleys 36A, 36B (in a counter-clockwise direction as shown in FIG. 1). Movement of the second hanger cable 38 about the second hanger pulleys 36A, 36B in this manner causes relative motion between the first and second door panel assemblies 12A, 12B.

Likewise, by virtue of the connection between the second hanger plate 18B and the third hanger cable 50, the third door panel assembly 12C is actuated by movement of the second door panel assembly 12B. As the second door panel assembly 12B moves towards the closed position, the connection between the second hanger plate 18B and the third hanger cable 50 causes the third hanger cable 50 to rotate about the third hanger pulleys 48A, 48B (in a counter-clockwise direction as shown in FIG. 1). Movement of the third hanger cable 50 about the third hanger pulleys 48A, 48B in this manner causes relative motion between the second and third door panel assemblies 12B, 12C.

As discussed above, the third hanger cable 50 is fixedly coupled to the housing 28, thus anchoring the three door panel assemblies 12A, 12B, 12C and limiting, in particular, motion of the third panel assembly 12C.

This arrangement and the interconnections allow for synchronized motion of the three door panel assemblies 12A, 12B, 12C such that upon application of force upon the handle 33 to close the elevator door assembly 10, motion of the first, second, and third door panel assemblies 12A, 12B, 12C is synchronized, such that the door panel assemblies begin to move substantially simultaneously and all three door panel assemblies 12A, 12B, 12C reach a respective fully closed position at substantially the same time.

The same is true in the opposite direction. This entire assembly and the interconnections allow for synchronized motion of the three door panel assemblies 12A, 12B, 12C such that upon application of force upon the handle 33 to open the elevator door assembly 10, motion of the first, second, and third door panel assemblies 12A, 12B, 12C is synchronized, such that the door panel assemblies 12A, 12B, 12C begin to move substantially simultaneously and all three door panel assemblies reach a respective fully opened position at substantially the same time.

In the embodiments relating to the synchronized movement of the door panel assemblies 12A, 12B, and 12C, it should be recognized that each door panel assembly may move at a different speed relative to a speed of each other door panel assembly to enable the door panel assemblies to reach a fully opened position or a fully closed position at substantially the same time. For example, first door panel assembly 12A must traverse substantially the entire length of first track 30A to reach a fully opened or closed position, but second door panel assembly 12B only needs to traverse an intermediate length of second track 30B to reach the fully opened or closed position. Third door panel assembly 12C needs to traverse the shortest length of third track 30C to reach the fully opened or closed position. As a result, first door panel assembly 12A will move at the fastest speed, second door panel assembly 12B will move at a slower speed than first door panel assembly 12A, and third door panel assembly 12C will move at the slowest speed of the door panel assemblies.

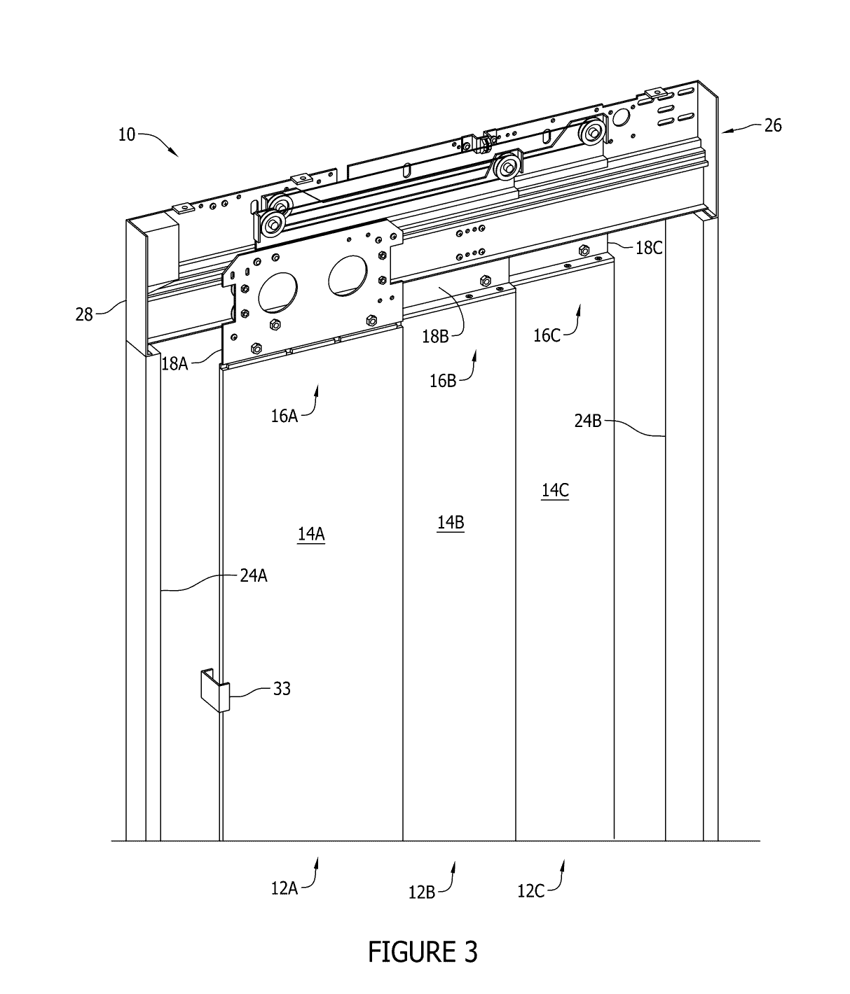

In one aspect of the present invention the components of the elevator door assembly 10 are designed to be adjustable such that one set of components can be assembled to allow both left hand and right hand orientation to be achieved simply by the method of assembly. This is demonstrated in FIG. 3, in which the same parts shown in the assembly of FIGS. 1 and 2, are arranged in the opposite orientation.

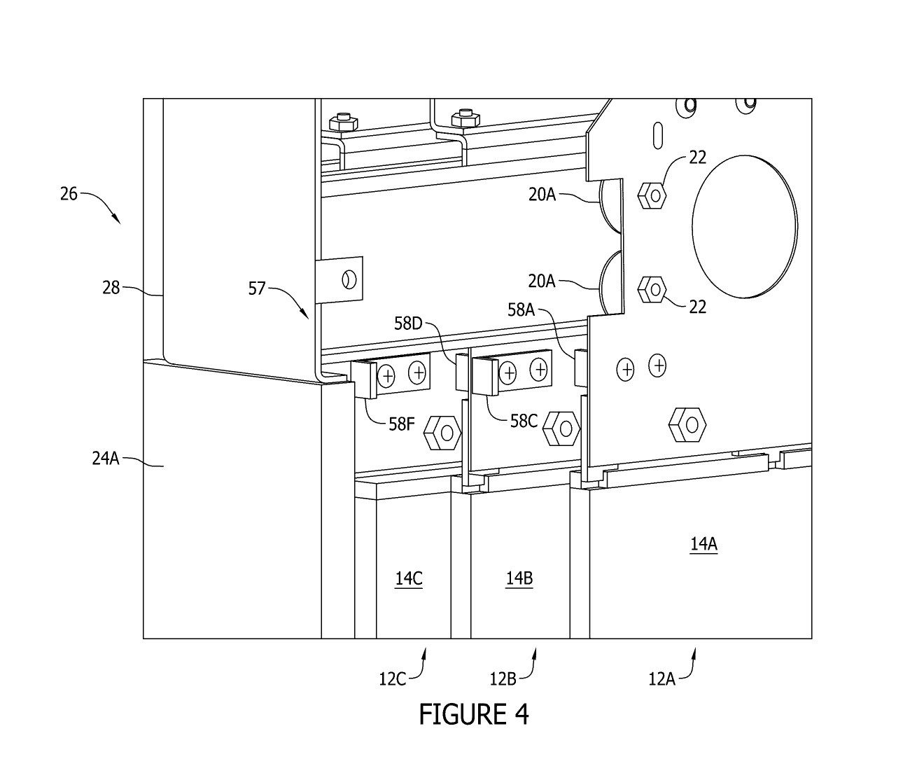

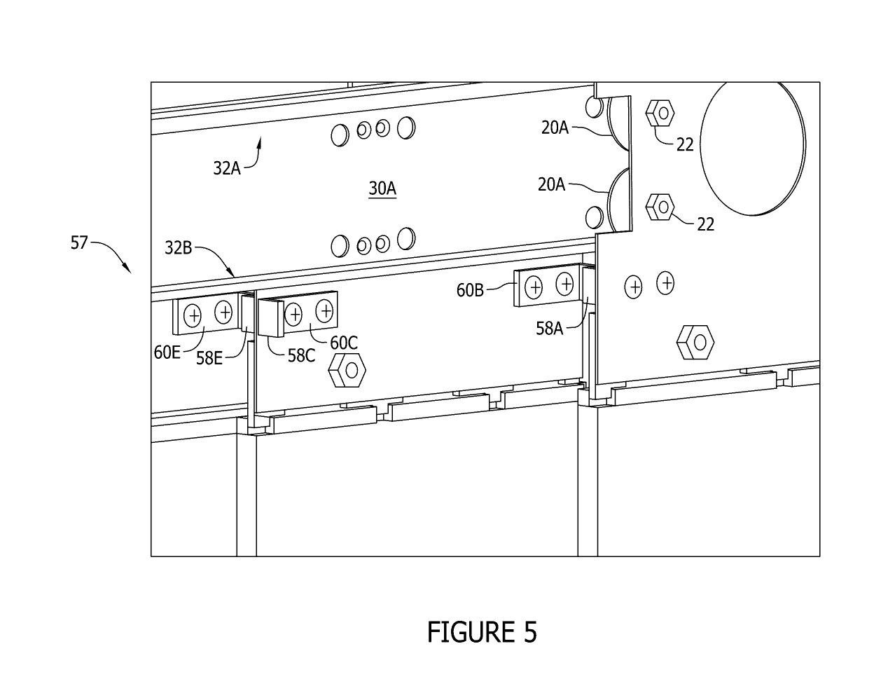

With reference to FIGS. 4-10, in another aspect of the present invention, a detent mechanism 57, which in the event of a failure of the flexible drive element (see below) or fixture in the synchronizer mechanism (see above), provide a mechanical back up fail-safe system. The detent mechanism 57 allows the door to be operated in a stepwise fashion (versus the normal synchronized fashion as when all elements are intact). This redundancy insures that a continuous door protection plane is maintained even in the event of drive member failures or other component failure.

As shown in FIGS. 4-9, in the illustrated embodiment, the detent mechanism 57 includes a plurality of tabs that allow or prevent relative movement of the panels 14A, 14B, and 14C depending on the current position of the assembly 10, i.e., fully opened, fully closed, or somewhere in between).

In the illustrated embodiment, a first tab 58A is formed by a first tab L-shaped bracket 60A mounted to the first hanger plate 18A. Second, third, and fourth tabs 58B, 58C, 58D are formed by second, third, and fourth tab L-shaped brackets 60B, 60C, 60D respectively, mounted to the second hanger plate 18B. Fifth and sixth tabs 58E, 58F are formed by fifth and sixth tab L-shaped brackets 60E, 60F, respectively mounted to the third hanger plate 18C.

With specific reference to FIGS. 6-9, the tabs 58A-58F either allow or prevent relative movement between the first, second and third door panels 14A, 14B, 14C. In FIG. 6, the elevator door assembly 10 is shown in an intermediate position, i.e., almost but not fully closed. As shown in this top down view, there is no contact between the tabs 58A-58F. Thus in a failure condition (see above), the first door panel 14A may be moved relative to the second door panel 14B. If the first door panel 14A is moved towards the closed position (to the right in FIG. 6), then once the first tab 58A comes into contact with the second tab 58B, continued movement of the first door panel 14A will move the second door panel 14B to the right. Likewise, once the fourth tab 58D comes into contact with the fifth tab 58E, continued movement of the second door panel 14B will move the third door panel 14C to the right. Although not shown in the drawings the spacer/fasteners that tie adjacent tracks together prevent any of the individual door panels from being moved an additional amount in the closed direction such that the door panels would move far enough beyond the end plane of the adjacent door panel so as to create an opening therebetween. Thus, the detent tabs 58A-58F prevent an individual door panel in the three door panel assembly from being able to move in the closed direction without moving the other door panels with it and the track spacer/fasteners prevent any of the three individual door panels from moving in the closed direction an amount that would compromise the protection plane of the door assembly.

As shown in FIG. 7, when there has been a failure in the synchronizer mechanism, once the elevator door assembly 10 is in the fully closed position, the first tab 58A is in contact with the second tab 58B and the fourth tab 58D is in contact with the fifth tab 58E. This relationship prevents movement of the second door panel 14B relative to either the first door panel 14A or the third door panel 14C, thus preventing creation of a gap between the first and second door panels 14A, 14B or the second and third door panels 14B, 14C during the failure condition.

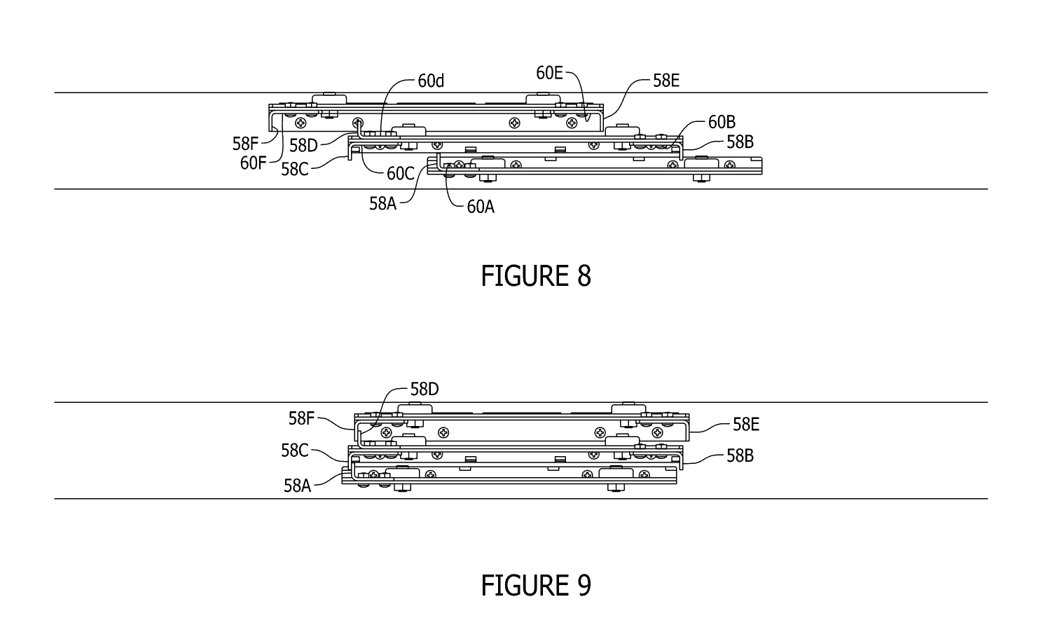

FIG. 8 illustrates the elevator door assembly 10 when the elevator door assembly is an almost fully open position with no failure of the synchronizer mechanism. In this embodiment, there is no contact between the tabs 58A-58F of the detent mechanism. FIG. 9 illustrates the elevator door assembly 10 when the elevator door assembly 10 is a fully open position, when there has been a failure in the synchronizer mechanism. As shown in FIG. 9, tab 58A is in contact with tab 58C, and tab 58D is in contact with 58F.

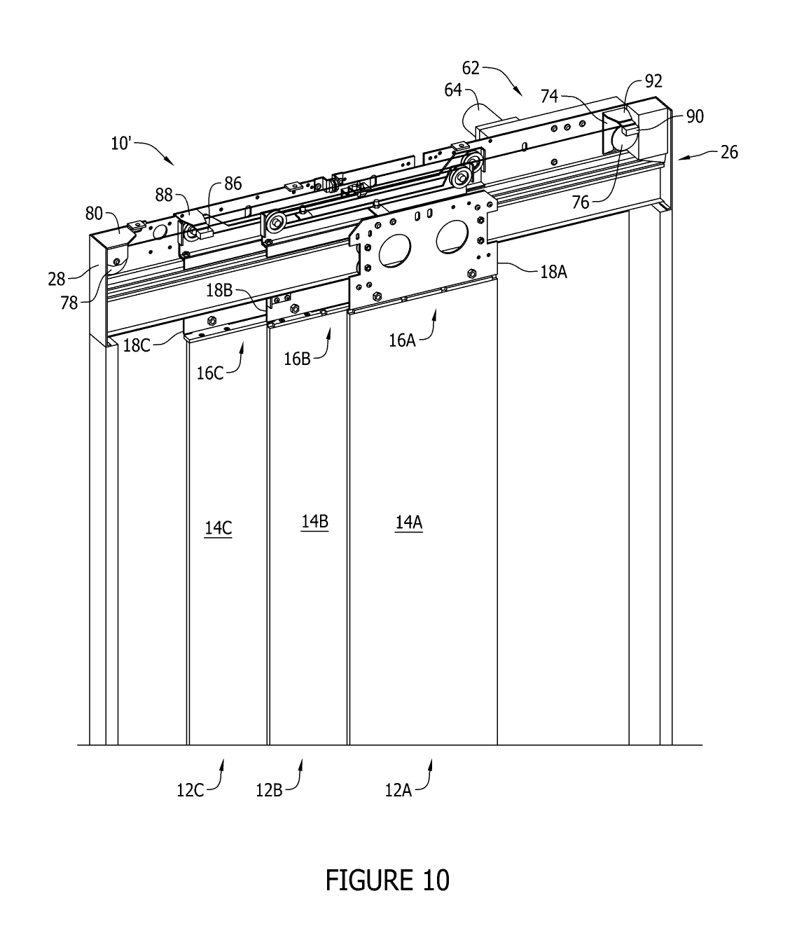

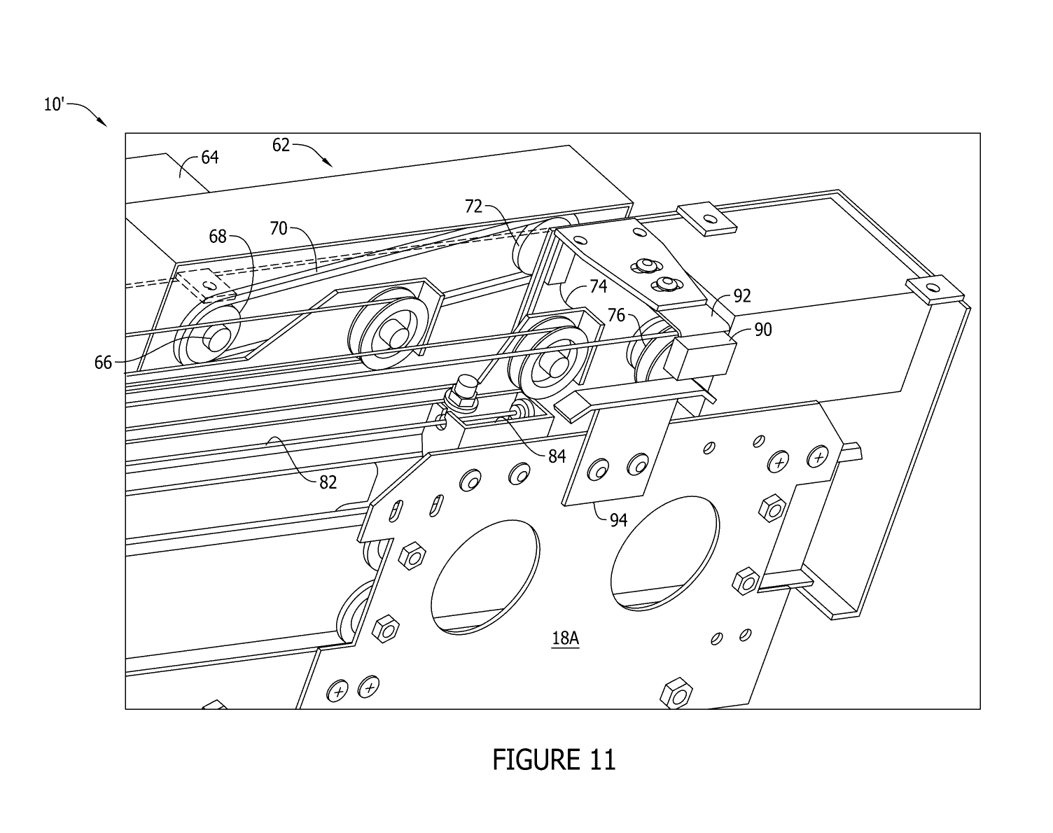

With specific reference FIGS. 10 and 11, in another embodiment of the present invention, a powered or motorized elevator door assembly 10′ is shown. It should be noted that in the illustrated embodiment, all other components are the same. However, instead of being manually operated, the door panel assemblies 12A, 12B, 12C are actuated through a drive mechanism 62.

In the illustrated embodiment, the drive mechanism 62 includes a motor 64 mounted to the upper assembly 26. The motor 64 is operated via a controller (not shown) to open and close the elevator door assembly 10′. The motor 64 includes a drive shaft 66. A first gear 68 mounted on the drive shaft 66 drives a chain 70. The chain rotates a second gear 72 that is coupled to a drive mechanism 74. The drive mechanism 74 under control of the motor 64 controllably rotates a first drive pulley 76. A second idler pulley 78 is rotatably mounted to the housing 28 of the upper assembly 26 via a bracket 80. A drive cable 82 is located about the first and second drive pulleys 76, 78. The first hanger plate 18A is fixedly coupled to the drive cable 82 via fixture 84.

The controller controllably operates the motor 64 in either one of two directions (clockwise and counter-clockwise). Through the gears and chain 68, 70, 72 the drive mechanism 74 drives the first drive pulley which rotates the drive cable 82 in an associated direction. The first door assembly 12A is fixedly coupled to the drive cable 82, and therefore moves in a horizontal direction along with the drive cable 82. Thus operation of the motor 64 is controlled by the controller to open and close the elevator door assembly 10′.

The elevator door assembly 10′ includes a first limit switch 86 mounted to the housing 28 of the upper assembly 26 by a bracket 88. A second limit switch 90 is mounted to the housing 28 of the upper assembly 26 by a bracket 92. A cam 94 mounted to the first hanger plate 18A actuates the first and second limit switches 86, 90, when the elevator door assembly 10′ reaches a near fully opened position and a near fully closed position, respectively. The limit switches 86, 90 send respective signals to the controller indicating when the near fully opened position or near fully closed position have been reached.

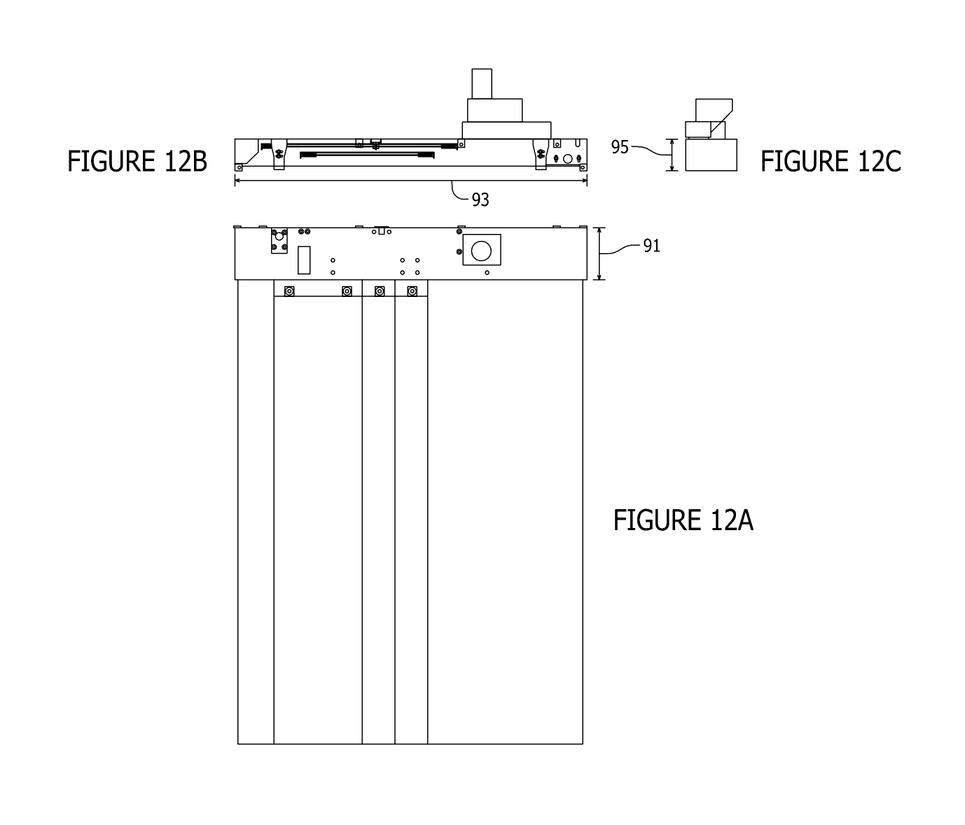

With reference to FIGS. 12A-12C, since the same components (other than the motive power source itself) are used in the manual elevator door assembly 10 (as shown in FIGS. 1-3) and the powered or motorized elevator door assembly 10′ (as shown in FIGS. 10 and 11, the drive components (other than the motor 64) are designed to allow either manual or powered operation within the same base envelope size (i.e., the same dimensions for housing the drive components). For example, the base envelope height 91, the base envelope width 93, and the base envelope depth 95 are substantially the same when the drive components used in the manual elevator door assembly 10 are installed as compared to when the drive components used in the motorized elevator door assembly 10′ (other than the motor 64) are installed.

As discussed above, the powered configuration 10′ employs a drive pulley/idler pulley arrangement with a flexible element that ties to the leading door carrier. To minimize envelope size of the drive system, in its preferred embodiment, the drive pulley shaft arrangement is located between the end of the carrier arm of the middle door in its closed position and the drive mechanical/electrical components on the inside of the mount frame, while the idler pulley is located at the stack end and mounts forward of the open position carrier assemblies. Its support can either utilize a rear mounted bracket that cantilevers over the end of all three door carrier assemblies or a side frame or front frame mount or a combination thereof.

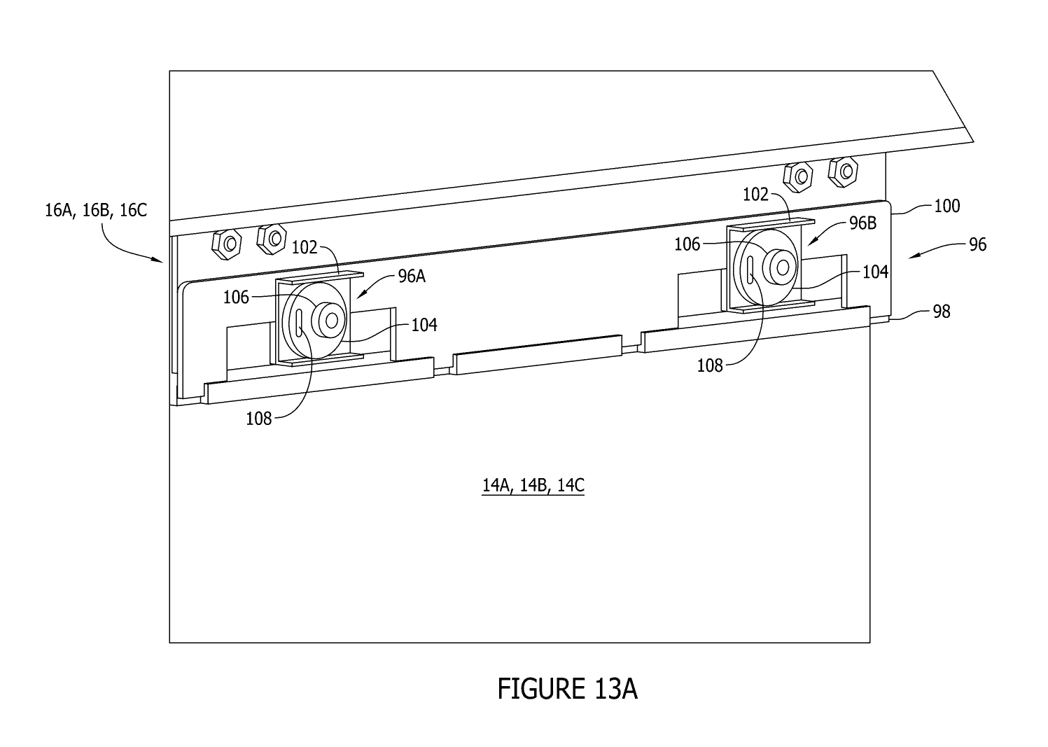

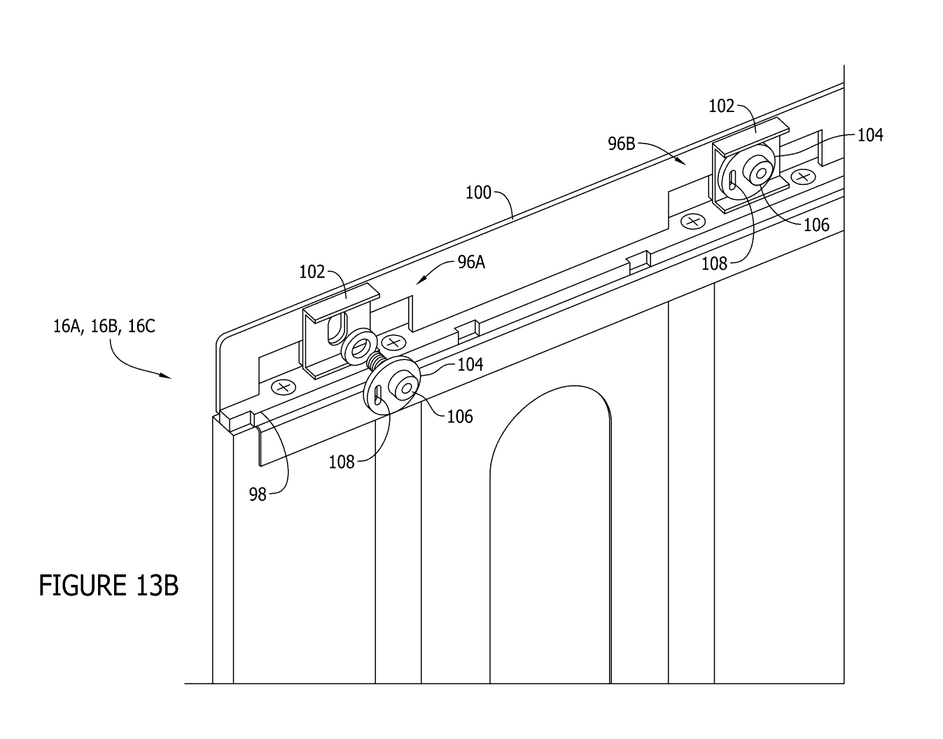

With reference to FIGS. 13A and 13B, in another aspect of the present invention, the elevator door assembly 10, 10′ may include an eccentric plate hanger assembly 96. Each door panel assembly 12A, 12B, 12C includes an associated eccentric plate hanger assembly 96 (only one of which is shown in FIGS. 13A and 13B). The eccentric plate hanger assembly 96 allows the door panel 14A, 14B, 14C to be adjustably mounted to the respective hanger assembly 16A, 16B, 16C.

As shown in FIGS. 13A and 13B, in the illustrated embodiment each eccentric plate hanger assembly 96 includes an intermediate member 98, an upper member 100, and a U-shaped member 102. The door panel 14A, 14B, 14C, intermediate member 98 upper member 100, and U-shaped member 102 are welded together. Door panels 14A, 14B, and 14C are fixed, e.g., by screws, to the resulting assembly. A pair of adjustment mechanisms 96A, 96B adjustably mounts the door panel 14A, 14B, 14C to the respective hanger assembly 16A, 16B, 16C. Each adjustment mechanism 98A, 98B includes U-shaped member 102, an inner disk 104, and a fastener mechanism 106. The inner disk 104 includes an aperture through which the fastener mechanism 106, e.g., a bolt, is inserted. The fastener mechanism or bolt 106 is mated with, e.g., a weld nut (not shown) located on the opposite side of the hanger plate 18A, 18B, 18C. The aperture in the inner disk 104 is offset from center of the inner disk 104. The inner disk 104 also includes a slot 108. The slot 108 may be used to adjust the positioning of the door panel 14A, 14B, 14C relative to the hanger assembly 16A, 16B, 16C. For instance, the fastener mechanism 106 may be pre-tightened to an amount that keeps the door panel 14A, 14B, 14C in place but allows for adjustment. A user may insert a tool, such as a screwdriver in the slot 108 and rotate the inner disk 104 about the offset aperture. An inner edge of the U-shaped member 102 rests on a top edge of the inner disk 104. Since the aperture in the inner disk 104 is offset from center, rotation of the inner disk 104 raises or lowers the door panel 14A, 14B, 14C. Once in the desired position, the fastener mechanism 106 may be fully tightened. Adjustment of the pair of adjust mechanisms 96A, 96B in this manner provides convenient and consistent door panel alignment and height adjustment.

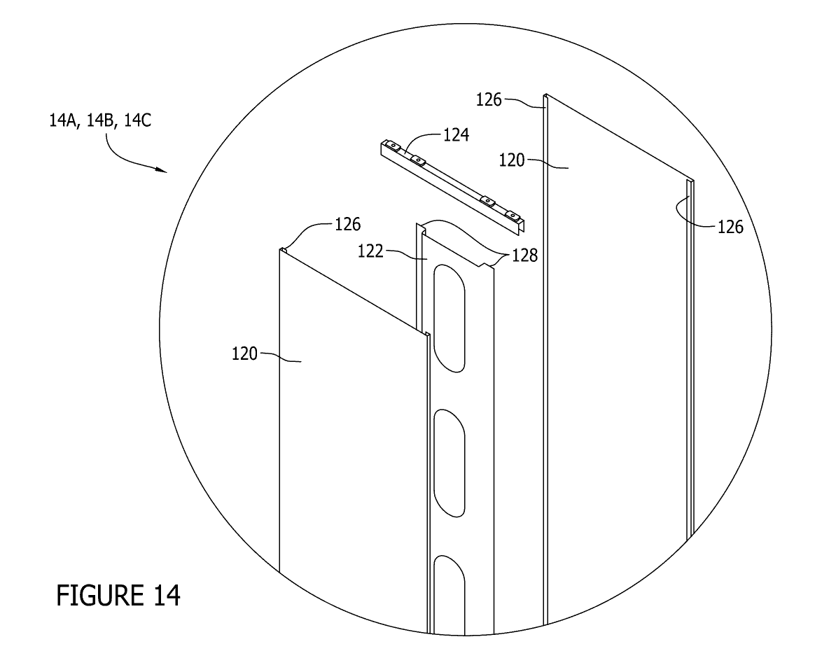

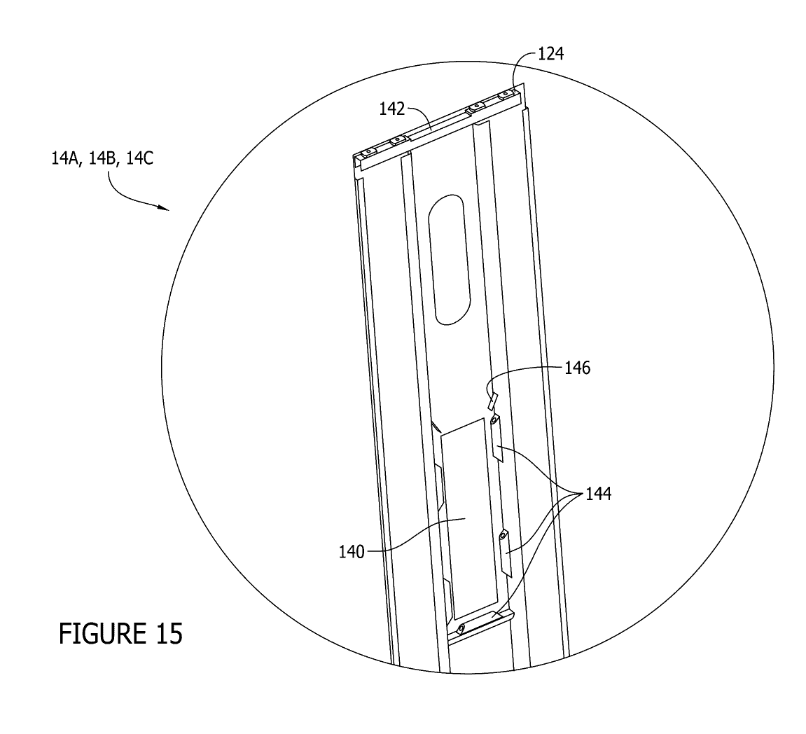

With reference to FIGS. 14 and 15, in another aspect of the door panels 14A, 14B, 14C may be constructed of formed outer skins 120 with an internal or center stiffener(s) 122 and formed top and bottom ends 124. In the illustrated embodiment, the outer skins 120 incorporate bent U-shaped edge flanges 126 that provide extra strength and also provide for a convenient joining surface between the panels along their edges. In the illustrated embodiment, the internal stiffener(s) 122 is a symmetric Z shaped form which provides a flat surface for joining on one side and double flanged flat joining surfaces on the other side. The front and back outer skins 120 and top and bottom ends 124 may be identical. The means of joining these door members together includes welding, high bonding tape, and high strength structural adhesives in various combinations.

The use of these different joining methods in various combinations provides the required strength as well as the dampening characteristic desired to prevent any “oil-canning” affects related to the construction and overall sound characteristics of a completed panel. In one arrangement, the internal stiffener 122 is welded in place to one of the outer skins 120 and bonded via high bonding tape 128 to the other outer skin 120, with both edges of the outer skin contact surfaces being welded together. The top and bottom ends 124 are similarly welded in place. This combination of welding and tape provides a structurally sound construction which also provides inherent dampening of the overall construction.

In another style of construction, a similar set of construction parts are joined together incorporating a structural adhesive to join the internal stiffener(s) 122 to the outer skins 120, the top and bottom ends 124, as well as both edges of the outer skin contact surfaces. This method of joining via high strength structural adhesives provides a structurally sound, inherently damped overall construction. Fixtures can be used in combination with built-in adhesive spacers to provide consistent, repeatable, finished panel dimensions. In essence, various combinations of the major joining techniques can be used to end up with the same overall finished door construction by only making minor dimensional changes to the parts.

With specific reference to FIG. 15, one or more of the door panels 14A, 14B, 14C, may include a window opening 140 for receiving a window. In this embodiment, the top and bottom ends 124 have a rectangular relief hole 42 provided in them that allows for sliding a window down into place after all other operations including painting are completed. Adhesive backed flexible stripping can be employed along the edges of the window panel and adhesive backed flexible bulb material 144 can be used around the internal locating flanges of the door internal stiffener to center and hold the window in place. Additionally, spring clips 146 may be strategically located along the edges of the internal stiffener flanges, which allow the window to be pushed by them while installing the window, and which lock the window in position vertically after the window passes them.

Obviously, many modifications and variations of the present invention are possible in light of the above teachings. The invention may be practiced otherwise than as specifically described within the scope of the appended claim.

What is claimed is:

1. An elevator door assembly, comprising:
a plurality of door panel assemblies, each door panel assembly comprising a respective door panel and an associated hanger assembly, the hanger assemblies being configured to provide synchronized opening and closing of the door panel assemblies; and
a detent mechanism coupled to the plurality of door panel assemblies to provide a mechanical back up mechanism that enables the door panel assemblies to be opened and closed in an event of a failure of at least one of the associated hanger assemblies.

2. The elevator door assembly of claim 1, wherein the detent mechanism comprises a tab coupled to each door panel.

3. The elevator door assembly of claim 2, wherein a tab coupled to a first door panel engages with a tab coupled to a second door panel to cause the second door panel to move in conjunction with the first door panel when the first door panel is moved.

4. The elevator door assembly of claim 1, wherein the detent mechanism comprises a first tab and a second tab coupled to a first door panel, and a third tab and a fourth tab coupled to a second door panel, wherein the first tab engages with the third tab to cause the first door panel and the second door panel to move together in a first direction, and wherein the second tab engages with the fourth tab to cause the first door panel and the second door panel to move together in a second direction opposite the first direction.

5. The elevator door assembly of claim 1, wherein the plurality of door panel assemblies comprises a first door panel assembly comprising a first door panel coupled to a first hanger assembly and a second door panel assembly having a second door panel coupled a second hanger assembly, the first hanger assembly comprising a first pulley mechanism that is coupled to the second hanger assembly to synchronize movement of the first door panel and the second door panel.

6. The elevator door assembly of claim 5, wherein the plurality of door panel assemblies further comprises a third door panel assembly comprising a third door panel coupled to a third hanger assembly, and wherein the second hanger assembly comprises a second pulley mechanism that is coupled to the third hanger assembly to synchronize movement of the second door panel and the third door panel.

7. The elevator door assembly of claim 6, wherein the first door panel, the second door panel, and the third door panel are movable towards a closed position and an open position, and wherein the first pulley mechanism enables the first door panel to be movable with a first speed and the second pulley mechanism enables the second door panel to be movable with a second speed that is slower than the first speed.

8. The elevator door assembly of claim 1, wherein the detent mechanism enables the door panel assemblies to operate in a first mode of operation in which the respective door panels are manually opened and closed in a step-wise manner.

9. The elevator door assembly of claim 8, wherein the hanger assemblies enable the door panel assemblies to operate in a second mode of operation in which the respective door panels are manually opened and closed in a synchronized manner.

10. The elevator door assembly of claim 9, further comprising a motor that engages at least one of the hanger assemblies to operate the plurality of door panel assemblies in a third mode of operation in which the respective door panels are opened and closed in a synchronized manner by the motor.

11. A method of assembling an elevator door, the method comprising:
providing a plurality of door panels and a plurality of hanger assemblies;
coupling each door panel of the plurality of door panels to a respective hanger assembly of the plurality of hanger assemblies to form a plurality of door panel assemblies, wherein the hanger assemblies provide synchronized opening and closing of the door panel assemblies; and
coupling a detent mechanism to the plurality of door panel assemblies to provide a mechanical back up mechanism that enables the door panel assemblies to be opened and closed in an event of a failure of at least one of the associated hanger assemblies.

12. The method of claim 11, wherein coupling the detent mechanism to the plurality of door panel assemblies comprises coupling a tab to each door panel.

13. The method of claim 11, wherein coupling the detent mechanism to the plurality of door panel assemblies further comprises coupling a tab to a first door panel of the plurality of door panels and coupling a tab to a second door panel of the plurality of door panels such that the tab of the first door panel engages with the tab extending from the second door panel to cause the second door panel to move in conjunction with the first door panel when the first door panel is moved.

14. The method of claim 11, wherein coupling the detent mechanism to the plurality of door panel assemblies comprises coupling a first tab and a second tab to a first door panel and coupling a third tab and a fourth tab to a second door panel, wherein the first tab engages with the third tab to cause the first door panel and the second door panel to move together in a first direction, and wherein the second tab engages with the fourth tab to cause the first door panel and the second door panel to move together in a second direction opposite the first direction.

15. The method of claim 11, wherein the plurality of door panels includes a first door panel and a second door panel, and wherein the plurality of hanger assemblies includes a first hanger assembly including a first pulley mechanism and a second hanger assembly including a second pulley mechanism, the method further comprising coupling the first pulley mechanism to the second hanger assembly to synchronize movement of the first door panel and the second door panel.

16. The method of claim 15, wherein the plurality of door panels includes a third door panel, and wherein the plurality of hanger assemblies includes a third hanger assembly, the method further comprising coupling the second pulley mechanism to the third hanger assembly to synchronize movement of the second door panel and the third door panel.

17. The method of claim 16, wherein the first door panel, the second door panel, and the third door panel are movable towards a closed position and an open position, and wherein the first pulley mechanism enables the first door panel to be movable with a first speed and the second pulley mechanism enables the second door panel to be movable with a second speed that is slower than the first speed.

18. The method of claim 11, wherein the detent mechanism enables the door panel assemblies to operate in a first mode of operation in which the respective door panels are manually opened and closed in a step-wise manner.

19. The method of claim 18, wherein the hanger assemblies enable the door panel assemblies to operate in a second mode of operation in which the respective door panels are manually opened and closed in a synchronized manner.

20. The method of claim 19, further comprising coupling a motor to at least one of the hanger assemblies to operate the plurality of door panel assemblies in a third mode of operation in which the respective door panels are opened and closed in a synchronized manner by the motor.
